(19) United States
(12) Patent Application Publication
(10) Pub. No.: US 2022/0059962 A1
(43) Pub. Date: Feb. 24, 2022

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Tetsuya MIYAMURA, Mie (JP)

(21) Appl. No.: 17/413,430

(22) PCT Filed: Dec. 6, 2019
(86) PCT No.: PCT/JP2019/047871

§ 371 Date: Jun. 11, 2021

(30) Foreign Application Priority Data
Dec. 25, 2018 (JP) 2018-240689

(51) Int. Cl. H01R 13/436

(52) U.S. Cl. CPC H01R 13/4367

(57) ABSTRACT

It is aimed to enable a functional member to be properly mounted on a housing. A connector includes terminal fittings (24) and a housing (10) into which the terminal fittings (24) are to be mounted. The housing (10) is formed with a lock arm (15) having a rear end part serving as an operating portion (18) for unlocking. The housing (10) includes a protecting portion (20) for covering the operating portion (18). The protecting portion (20) is formed with a receiving portion (23). A retainer (30) is mounted on a rear end part of the housing (10). The retainer (30) is formed with a fit-in portion (38) fittable to the receiving portion (23) when the retainer (30) is properly mounted on the housing (10).

### TECHNICAL FIELD

The present disclosure relates to a connector.

### BACKGROUND

Patent Document 1 discloses a connector including a housing, a terminal fitting and a retainer. The terminal fitting is inserted into the housing from behind the housing. The retainer is mounted on a rear end part of the housing after the terminal fitting is inserted. With the retainer mounted, a retaining portion of the retainer is in contact with the terminal fitting from behind, whereby the terminal fitting is held in a retained state.

### PRIOR ART DOCUMENT

### Patent Document

Patent Document 1: JP H11-067318 A

### SUMMARY OF THE INVENTION

### Problems to be Solved

In recent years, the miniaturization of connectors has progressed. If the terminal fitting and the retaining portion of the retainer are miniaturized, even a slight displacement of the retaining portion with respect to the terminal fitting may reduce a retaining function by the retainer. Such a problem similarly occurs in various functional members mounted in or on housings without limitation to retainers for retaining terminal fittings.

A connector of the present disclosure was completed on the basis of the above situation and is designed to enable a functional member to be properly mounted on a housing.

### Means to Solve the Problem

The present disclosure is directed to a connector with a terminal fitting and a housing, the terminal fitting being mounted into the housing, wherein the housing is formed with a lock arm having a rear end part serving as an operating portion for unlocking, the housing includes a protecting portion for covering the operating portion, the protecting portion is formed with a receiving portion, a functional member is mounted on a rear end part of the housing, and the functional member is formed with a fit-in portion fittable to the receiving portion when the functional member is properly mounted on the housing.

### Effect of the Invention

According to the present disclosure, a functional member can be held in a state properly mounted on a housing.

### BRIEF DESCRIPTION OF THE DRAWINGS

FIG. 1 is a back view showing a state where a female connector of a first embodiment is connected to a male connector.

FIG. 2 is a plan view showing the state where the female connector is connected to the male connector.

FIG. 3 is a section along A-A of FIG. 1.

FIG. 4 is a front view of a female housing.

FIG. 5 is a plan view of the female housing.

FIG. 6 is a front view of a retainer.

FIG. 7 is a plan view of the retainer.

FIG. 8 is a section along B-B of FIG. 6.

FIG. 9 is a plan view showing a state where a female connector of a second embodiment is connected to a male connector.

FIG. 10 is a section along C-C of FIG. 9.

FIG. 11 is a back view of a female housing.

FIG. 12 is a plan view of the female housing.

FIG. 13 is a plan view of a retainer.

FIG. 14 is a back view showing a state where a female connector of a third embodiment is connected to a male connector.

FIG. 15 is a plan view showing the state where the female connector is connected to the male connector.

FIG. 16 is a section along D-D of FIG. 14.

FIG. 17 is a plan view of a female housing.

FIG. 18 is a side view of the female housing.

FIG. 19 is a plan view of a retainer.

FIG. 20 is a section along E-E of FIG. 19.

### DETAILED DESCRIPTION TO EXECUTE THE INVENTION

### Description of Embodiments of Present Disclosure

First, embodiments of the present disclosure are listed and described.

(1) The connector of the present disclosure includes a terminal fitting and a housing, the terminal fitting being mounted into the housing, wherein the housing is formed with a lock arm having a rear end part serving as an operating portion for unlocking, the housing includes a protecting portion for covering the operating portion, the protecting portion is formed with a receiving portion, a functional member is mounted on a rear end part of the housing, and the functional member is formed with a fit-in portion fittable to the receiving portion when the functional member is properly mounted on the housing.

According to the configuration of the present disclosure, if the functional member is properly mounted on the housing, the fit-in portion and the receiving portion are fit, whereby the functional member is positioned with respect to the housing. In this way, the functional member can be held in a state properly mounted on the housing.

(2) Preferably, the functional member is formed with a covering portion for covering a region of the operating portion not covered by the protecting portion. According to this configuration, since the operating portion is covered not only by the protecting portion, but also by the covering portion, the operating portion can be protected from interference with external matters.

(3) Preferably, the fit-in portion is integrally formed to the covering portion. According to this configuration, a position shift of the covering portion with respect to the protecting portion can be prevented by the fitting of the receiving portion and the fit-in portion.

(4) Preferably, the protecting portion is in the form of a frame extending from an outer surface of the housing and surrounding the operating portion, the receiving portion is formed by recessing a facing surface of the protecting portion facing the operating portion, and the fit-in portion is fit to the receiving portion while projecting from the functional member and slipping into the inside of the protecting portion. According to this configuration, since a fit part of the receiving portion and the fit-in portion is located inside the protecting portion, the fit part of the receiving portion and the fit-in portion is free from interference with external matters.

(5) Preferably, a pair of the protecting portions are cantilevered from an outer surface of the housing and disposed to laterally sandwich the operating portion, extending end parts of the pair of protecting portions function as the receiving portions, and the fit-in portion is fit between the pair of receiving portions. According to this configuration, a fit state of the receiving portion and the fit-in portion can be visually confirmed.

(6) Preferably, the functional member includes an opening penetrating in a front-rear direction, an opening edge part of the opening serves as the fit-in portion, the protecting portion is in the form of a frame extending from an outer surface of the housing and surrounding the operating portion, and the receiving portion is cantilevered from the protecting portion and fit to the fit-in portion while being accommodated in the opening. According to this configuration, since the fit part of the receiving portion and the fit-in portion is located inside the opening, the fit part of the receiving portion and the fit-in portion is free from interference with external matters.

(7) Preferably, the terminal fitting is inserted into the housing from behind, and the functional member is a retainer for holding the terminal fitting in a retained state by being mounted on the rear end part of the housing.

### Details of Embodiments of Present Disclosure

### First Embodiment

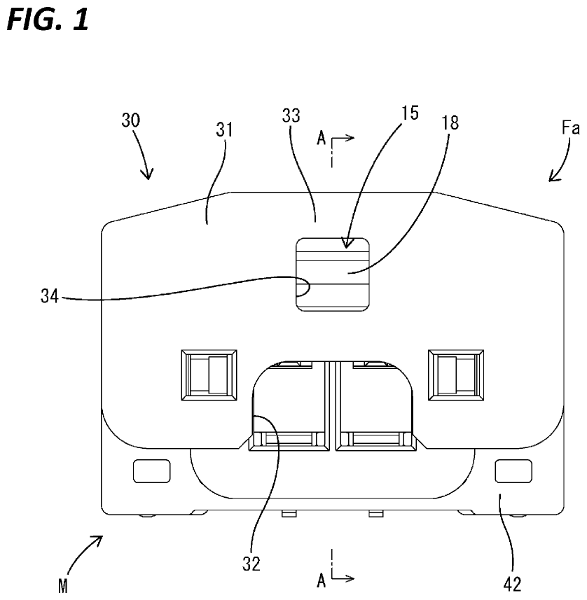

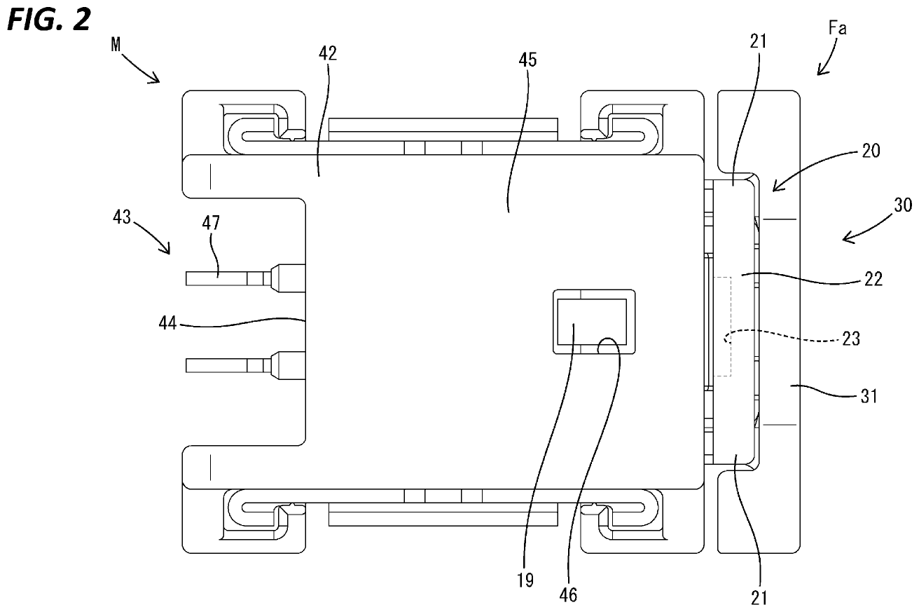

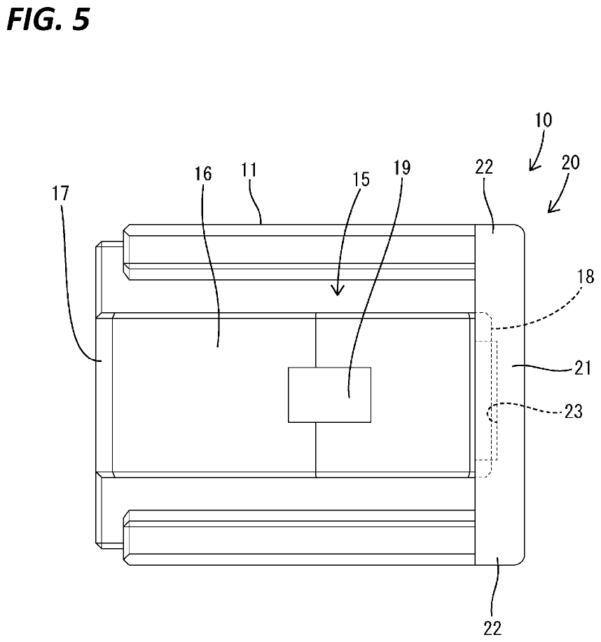

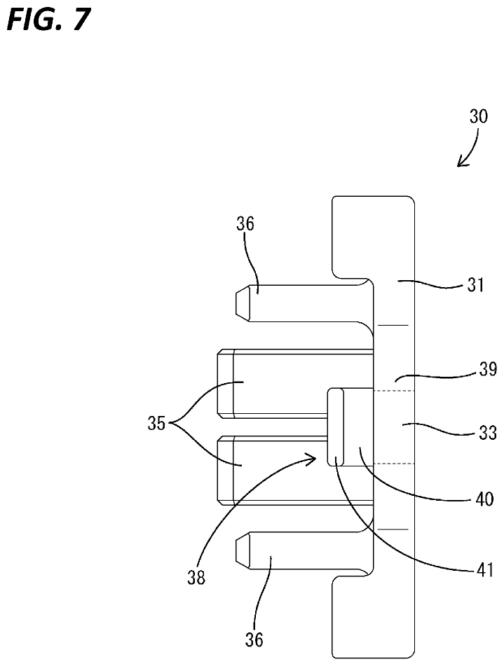

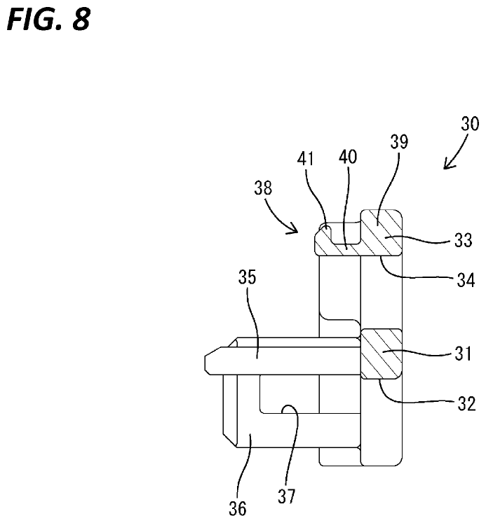

A first specific embodiment of a connector of the present disclosure is described with reference to FIGS. 1 to 8. Note that the present invention is not limited to these illustrations and is intended to be represented by claims and include all changes in the scope of claims and in the meaning and scope of equivalents. In the first embodiment, a left side in FIGS. 2, 3, 5, 7 and 8 is defined as a front side concerning a front-rear direction. Upper and lower sides shown in FIGS. 1, 3, 4, 6 and 8 are directly defined as upper and lower sides concerning a vertical direction.

A female connector Fa of the first embodiment includes a female housing 10 made of synthetic resin, a pair of female terminal fittings 24 and a retainer 30 made of synthetic resin and serving as a functional member.

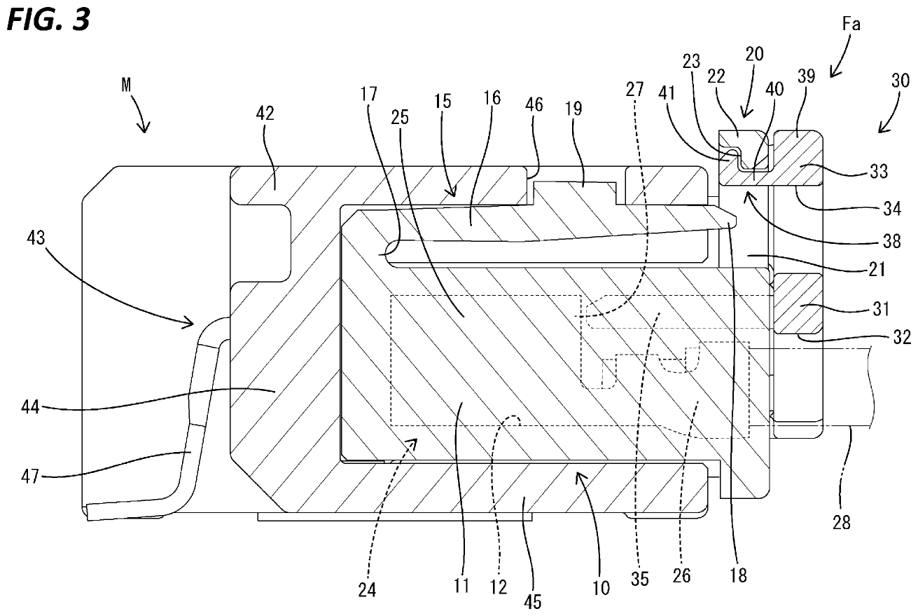

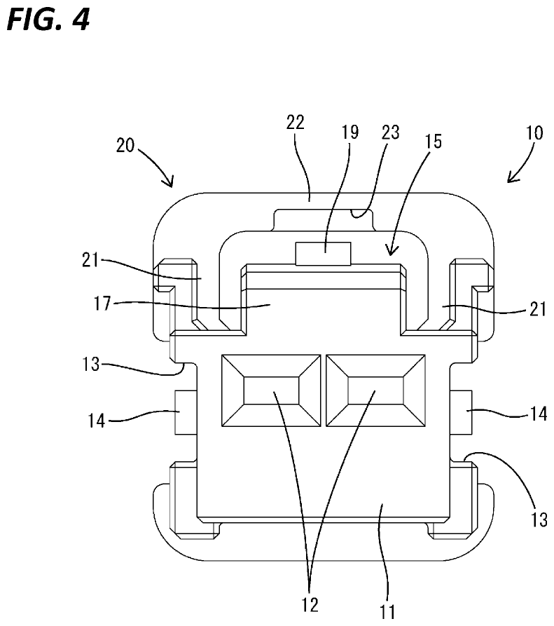

As shown in FIGS. 3 to 5, the female housing 10 is a single member integrally formed with a terminal accommodating portion 11, a lock arm 15 and a protecting portion 20. The terminal accommodating portion 11 is in the form of a block as a whole and a pair of left and right terminal accommodation chambers 12 are formed laterally side by side in the terminal accommodating portion 11. A locking lance (not shown) resiliently deformable in the vertical direction is formed at the lower surface of the terminal accommodation chamber 12. The rear end of the terminal accommodation chamber 12 is open as a terminal insertion opening in the rear end surface of the terminal accommodating portion 11 (female housing 10). As shown in FIG. 4, a pair of left and right guide recesses 13 open in the rear end surface of the terminal accommodating portion 11 are formed in both left and right outer surfaces of the terminal accommodating portion 11. A pair of left and right locking projections 14 are formed in the pair of guide recesses 13.

As shown in FIG. 3, the lock arm 15 is disposed along the upper surface (outer surface) of the terminal accommodating portion 11. The lock arm 15 includes an arm body portion 16 elongated in the front-rear direction along the upper surface of the terminal accommodating portion 11, a supporting portion 17 extending downward from a front end part of the arm body portion 16 and connected to the upper surface of the terminal accommodating portion 11, and an operating portion 18 for unlocking formed on a rear end part of the arm body portion 16.

The lock arm 15 is resiliently deformable in the vertical direction with the supporting portion 17 serving as a fulcrum. A lock projection 19 is formed at a position forward of the operating portion 18 on the upper surface of the arm body portion 16. The operating portion 18 is formed by extending the rear end of the arm body portion 16 rearward. If a downward force acts on the operating portion 18, the lock arm 15 is displaced in an unlocking direction.

The protecting portion 20 is a part for protecting the operating portion 18 from interference with external matters. As shown in FIGS. 3 and 4, the protecting portion 20 is formed into a frame shape by a pair of left and right side surface protecting portions 21 and an upper surface protecting portion 22. The pair of left and right side surface protecting portions 21 are disposed to extend upward (toward the lock arm 15) from a rear end part of the upper surface of the terminal accommodating portion 11 and cover both left and right side surfaces of the operating portion 18. The upper surface protecting portion 22 couples upper end parts of the pair of left and right side surface protecting portions 21, and is disposed to cover the upper surface of the operating portion 18. The protecting portion 20 prevents only the interference of external matters with the operating portion 18 from above and the interference of external matters with the operating portion 18 from both left and right sides. The protecting portion 20 and the female housing 10 are not formed with a part for covering the operating portion 18 from behind.

As shown in FIGS. 3 and 4, the protecting portion 20 is integrally formed with a receiving portion 23. The receiving portion 23 is disposed in a laterally central part of the upper surface protecting portion 22, i.e. in a region corresponding to the operating portion 18 in a lateral direction. The receiving portion 23 is formed by recessing a part of a region of the upper surface protecting portion 22 facing the upper surface of the operating portion 18. In particular, the receiving portion 23 is formed by recessing a front edge part of the lower surface of the upper surface protecting portion 22 and a lower end edge part of the front surface of the upper surface protecting portion 22 into a groove. In other words, the receiving portion 23 is open downward of the upper surface protecting portion 22 and forward of the upper surface protecting portion 22. The receiving portion 23 is in such a positional relationship as to vertically face the upper surface of the operating portion 18.

As shown in FIG. 3, the female terminal fitting 24 includes a rectangular tube portion 25 in a front end part and a crimping portion 26 in the form of an open barrel in a rear end part. A resilient contact piece (not shown) is accommodated in the rectangular tube portion 25. A projection-like primary locking portion (not shown) is formed on the lower surface of the rectangular tube portion 25. A rear part of the rectangular tube portion 25 functions as a secondary locking portion 27. The crimping portion 26 is conductively crimped to a coated wire 28.

The female terminal fitting 24 is inserted into the terminal accommodation chamber 12 from behind the female housing 10. Although not shown, the properly inserted female terminal fitting 24 is held in a retained state by a primary locking structure for hooking the primary locking portion to a locking lance. The coated wire 28 fixed to the female terminal fitting 24 is drawn out rearward from the female housing 10.

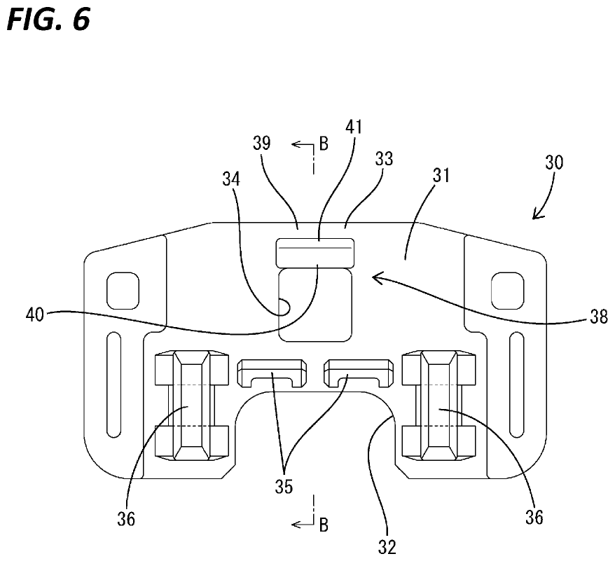

As shown in FIGS. 6 to 8, the retainer 30 is a single component including a wall portion 31, a pair of left and right retaining projections 35 and a pair of left and right resilient locking pieces 36. The wall portion 31 is substantially in the form of a flat plate having a wall thickness direction aligned with the front-rear direction (direction parallel to mounting and withdrawing directions of the female terminal fitting 24 into and from the female housing 10). A view viewed in the same direction as the mounting direction of the female terminal fitting 24 into the female housing 10 with the retainer 30 mounted on the female housing 10 is defined as a back view.

In the back view, the wall portion 31 is shaped and dimensioned to cover at least the entire protecting portion 20 and a part of the operating portion 18, out of the rear surface of the female housing 10. The wall portion 31 is formed with an escaping recess 32 by cutting a region corresponding to the plurality of terminal accommodation chambers 12 in the back view. The escaping recess 32 is open in the lower end edge of the wall portion 31.

A part of the wall portion 31 has a function as a covering portion 33. That is, a central part in the lateral direction of the wall portion 31 above a vertical center height constitutes the covering portion 33. In other words, a region of the wall portion 31 corresponding to the entire protecting portion 20 in the back view and regions of the wall portion 31 corresponding to both left and right end parts of the operating portion 18 in the back view function as the covering portion 33.

As shown in FIGS. 1, 3, 6 and 8, the wall portion 31 is formed with an operation hole 34 penetrating in the front-rear direction (thickness direction of the wall portion 31). The operation hole 34 is a rectangular opening open in a region corresponding only to a laterally central part of the operating portion 18 in the back view. An upper end edge in an opening region of the operation hole 34 is set at a position above the upper surface of the operating portion 18 and below the lower surface of the upper surface protecting portion 22 when the lock arm 15 is in a free state without being resiliently deflected. A lower end edge in the opening region of the operation hole 34 is located substantially at the same height as the upper surface of the terminal accommodating portion 11.

The pair of left and right retaining projections 35 are cantilevered forward from the front surface (surface facing the rear surface of the female housing 10) of the wall portion 31. The pair of retaining projections 35 are disposed at positions corresponding to the secondary locking portions 27 of the female terminal fittings 24 in the vertical and lateral directions (in the back view). The pair of left and right resilient locking pieces 36 are cantilevered forward from both left and right side edges of the wall portion 31. The resilient locking piece 36 is formed with a locking hole 37 penetrating in the lateral direction. The resilient locking piece 36 is resiliently deformable in the lateral direction.

As shown in FIGS. 3 and 6 to 8, the retainer 30 is integrally formed with a fit-in portion 38. The fit-in portion 38 is cantilevered forward from the front surface of the wall portion 31. A formation range of the fit-in portion 38 in the lateral direction is a region corresponding to the receiving portion 23, i.e. a laterally central part of the retainer 30 (wall portion 31). A formation range of the fit-in portion 38 in the vertical direction is a region substantially corresponding to the receiving portion 23.

The fit-in portion 38 is composed of a base portion 40 in the form of a flat plate and a projection 41. The base portion 40 is cantilevered forward from an upper edge part 39 of the opening edge of the operation hole 34 in the front surface of the wall portion 31. The projection 41 projects upward from the projecting end edge of the base portion 40. A shape viewed from a direction orthogonal to both a resilient displacement direction of the lock arm 15 and a mounting direction of the retainer 30 on the female housing 10 is defined as a side view shape. The side view shape of the fit-in portion 38 is a substantially L shape. With the retainer 30 properly mounted on the female housing 10, the projection 41 of the fit-in portion 38 is fit to the receiving portion 23 of the female housing 10.

After the female terminal fittings 24 are inserted into the female housing 10, the retainer 30 is assembled with the rear end part of the female housing 10 (terminal accommodating portion 11). In assembling, the escaping recess 32 is fit from above to regions of the coated wires 28 drawn out rearward from the female housing 10. Then, the wall portion 31 of the retainer 30 is brought closer to the female housing 10 from behind while the resilient locking pieces 36 are fit into the guide recesses 13. As the wall portion 31 approaches the rear end of the terminal accommodating portion 11, the retaining projections 35 are inserted into the terminal accommodation chambers 12.

When the retainer 30 reaches a properly assembled state, the locking holes 37 of the both left and right resilient locking pieces 36 are locked to the pair of locking projections 14, whereby the retainer 30 is locked in a state assembled with the female housing 10. Further, the retaining projections 35 come into contact with the secondary locking portions 27 of the female terminal fittings 24 from behind or approach from behind to face the secondary locking portions 27. The female terminal fittings 24 are reliably held in a retained state by a primary locking action by the locking lances and a secondary locking action by the retainer 30.

If the retainer 30 is properly mounted on the female housing 10 as shown in FIG. 3, the projection 41 of the fit-in portion 38 is fit to the receiving portion 23 of the female housing 10. By the fitting of the fit-in portion 38 to the receiving portion 23, a rearward relative displacement of the retainer 30 with respect to the female housing 10 and a lateral relative displacement of the retainer 30 with respect to the female housing 10 are restricted. In this way, the wall portion 31 of the retainer 30 is held in a proper positional relationship with respect to the terminal accommodating portion 11. The retaining projections 35 formed on the wall portion 31 and the secondary locking portions 27 of the female terminal fittings 24 accommodated in the terminal accommodating portion 11 are also held in a proper positional relationship. Therefore, the reliability of a function of retaining the female terminal fittings 24 by the retainer 30 is excellent.

A state viewed from a direction orthogonal to a mounting direction of the retainer 30 on the female housing 10 and a facing direction of the pair of left and right resilient locking pieces 36 is defined as a plan view. In the plan view, if the retainer 30 is mounted in an oblique posture (i.e. improper posture) with respect to the female housing 10, the locking hole 37 of one 36 of the pair of left and right resilient locking pieces 36 is locked to the locking projection 14 of the female housing 10 and the locking hole 37 of the other resilient locking piece 36 is not locked to the locking projection 14. In this case, the projection 41 of the fit-in portion 38 is kept at a position behind the receiving portion 23 and the fit-in portion 38 cannot be fit to the receiving portion 23. Thus, the retainer 30 is relatively displaceable with respect to the female housing 10 and the position of the retainer 30 with respect to the female housing 10 is not stable.

Further, with the retainer 30 properly assembled with the female housing 10, the covering portion 33 covers the operating portion 18 of the lock arm 15 from behind. Thus, even if an external matter approaches the operating portion 18 from behind, there is no possibility that that external matter contacts the operating portion 18. Further, the covering portion 33 is arranged in proximity to the protecting portion 20 in the front-rear direction. Thus, there is no possibility that an external matter intrudes through a clearance between the front surface of the covering portion 33 and the rear surface of the protecting portion 20.

As shown in FIG. 3, the female connector Fa is connectable to a male connector M. The male connector M functions as a board connector to be mounted on a circuit board (not shown). The male connector M includes a male housing 42 and a pair of male terminal fittings 43 mounted in the male housing 42. The male housing 42 includes a wall-like terminal penetrating portion 44 and a receptacle 45 in the form of a rectangular tube projecting toward a front side (toward the female connector Fa) from the outer peripheral edge of the terminal penetrating portion 44. A lock hole 46 is formed in an upper surface part constituting the receptacle 45. The male terminal fittings 43 are passed through the terminal penetrating portion 44. Tabs (not shown) on the tips of the male terminal fittings 43 are accommodated in the receptacle 45. Board connecting portions 47 of the male terminal fittings 43 are soldered and fixed to the circuit board (not shown).

In the process of connecting the female connector Fa to the male connector M, the lock projection 19 interferes with the upper surface part of the receptacle 45, whereby the lock arm 15 is resiliently deflected downward. When the both connectors Fa, M reach a properly connected state, the lock arm 15 resiliently returns to lock the lock projection 19 into the lock hole 46. By this locking of the lock projection 19 and the lock hole 46, the both connectors Fa, M are locked in the connected state.

If a worker connects the both connectors Fa, M while pinching the operating portion 18 with fingers and releases the fingers from the operating portion 18 after the operation, the lock arm 15 does not vigorously resiliently return. Thus, the arm body portion 16 does not collide with the upper surface part of the receptacle 45. Accordingly, no impact sound is produced and an impact (click feeling) due to a collision is not transferred to the worker pinching the female connector Fa. Therefore, the worker cannot judge whether or not the both connectors Fa, M have been properly connected.

As a countermeasure against this, in the first embodiment, the retainer 30 is formed with the covering portion 33 for covering the operating portion 18 from behind. In this way, even if the wall portion 31 of the retainer 30 is pushed with fingers from behind in pushing the female connector Fa into the receptacle 45 of the male connector M, the fingers do not contact the operating portion 18. Thus, when the both connectors Fa, M are properly connected, the lock arm 15 certainly resiliently returns due to a resilient restoring force of the lock arm 15 and the upper surface of the arm body portion 16 reliably collides with the upper surface part of the receptacle 45. By this collision, an impact sound is produced and an impact (click feeling) due to the collision is transferred to the worker pinching the female connector Fa. By the collision sound and the click feeling, the worker can judge that the both connectors Fa, M have been properly connected.

In separating the both connectors Fa, M in the connected state, a jig (not shown) is inserted into the operation hole 34 from behind the retainer 30 and the tip of the jig is brought into contact with the upper surface of the operating portion 18. Since the lock arm 15 is resiliently deflected in the unlocking direction if a tip part of the jig is displaced downward, the lock projection 19 is released from the lock hole 46 and the locked state of the both connectors Fa, M is released. Thereafter, the female connector Fa may be pulled out from the receptacle 45 while the unlocked state is maintained.

The female connector Fa of the first embodiment includes the female housing 10 into which the female terminal fittings 24 are to be mounted, and the retainer 30 to be mounted on the rear end part of the female housing 10 (terminal accommodating portion 11). The female housing 10 is formed with the lock arm 15 having the rear end part serving as the operating portion 18 for unlocking. The female housing 10 is formed with the protecting portion 20 for covering the operating portion 18. The protecting portion 20 is formed with the receiving portion 23. The retainer 30 is formed with the fit-in portion 38 to be fit to the receiving portion 23 only when the retainer 30 is properly mounted on the female housing 10.

According to this configuration, if the retainer 30 is properly mounted on the female housing 10, the fit-in portion 38 is fit to the receiving portion 23 and the retainer 30 is positioned with respect to the female housing 10 by the fitting of the receiving portion 23 and the fit-in portion 38. In this way, the retainer 30 can be held in a state properly mounted on the female housing 10. This enables the retainer 30 to properly exhibit a desired function (function of retaining the female terminal fittings 24).

Further, the retainer 30 is formed with the cover portion 33 for covering the region of the operating portion 18 not covered by the protecting portion 20 (rear surface of the operating portion 18). Since the operating portion 18 is covered not only by the protecting portion 20, but also by the cover portion 33 in this way, the operating portion 18 can be protected from interference with external matters. Further, since the fit-in portion 38 is integrally formed to the cover portion 33, a position shift of the cover portion 33 with respect to the protecting portion 20 can be prevented by the fitting of the receiving portion 23 and the fit-in portion 38.

Further, the protecting portion 20 is in the form of a frame extending from the outer surface of the female housing 10 (upper surface of the terminal accommodating portion 11) and surrounding the operating portion 18, and the receiving portion 23 is formed by recessing the facing surface of the protecting portion 20 facing the operating portion 18. The fit-in portion 38 projects forward (same direction as an assembling direction of the retainer 30 with the female housing 10) from the retainer 30 and is fit to the receiving portion 23 while slipping into the inside of the protecting portion 20. According to this configuration, since a fit part of the receiving portion 23 and the fit-in portion 38 is located inside the protecting portion 20, the fit part of the receiving portion 23 and the fit-in portion 38 is free from interference with external matters.

### Second Embodiment

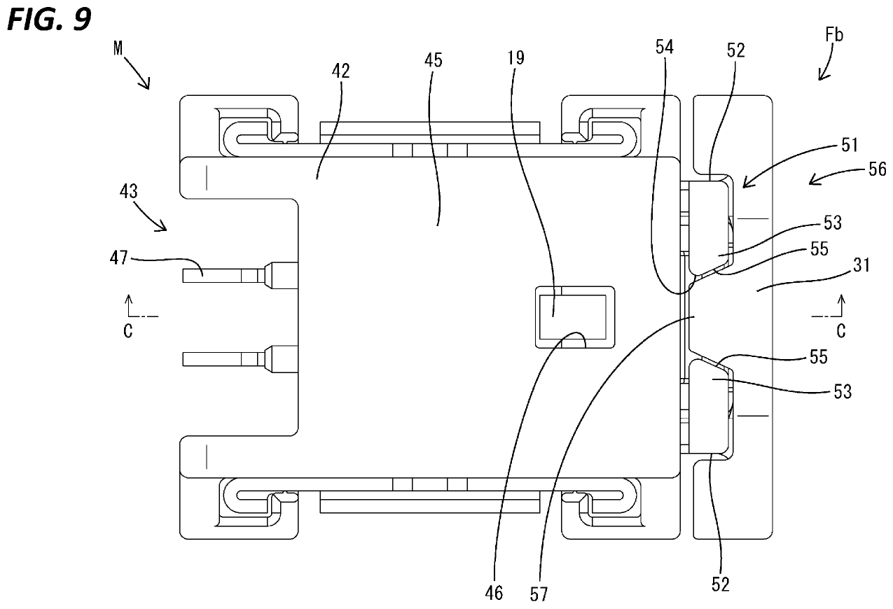

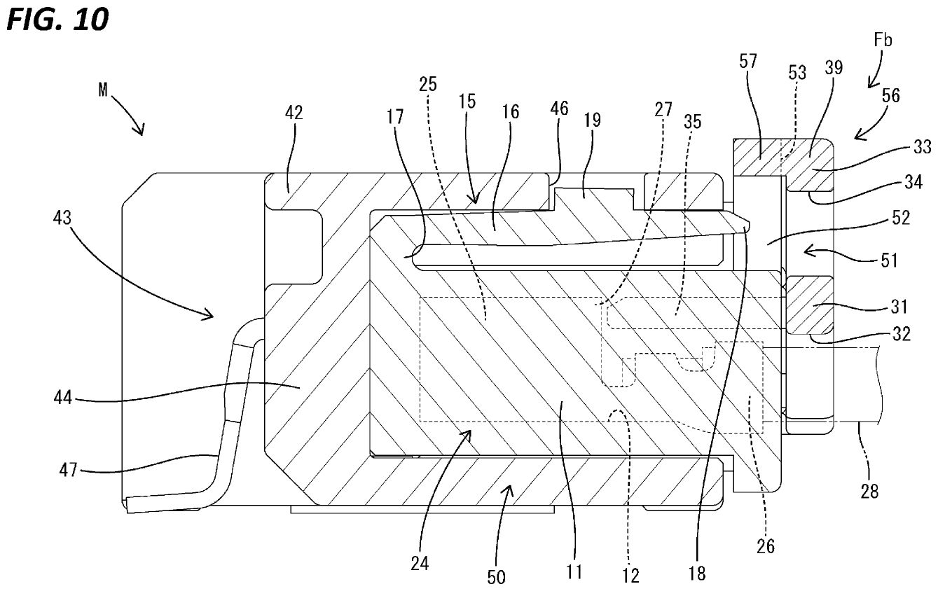

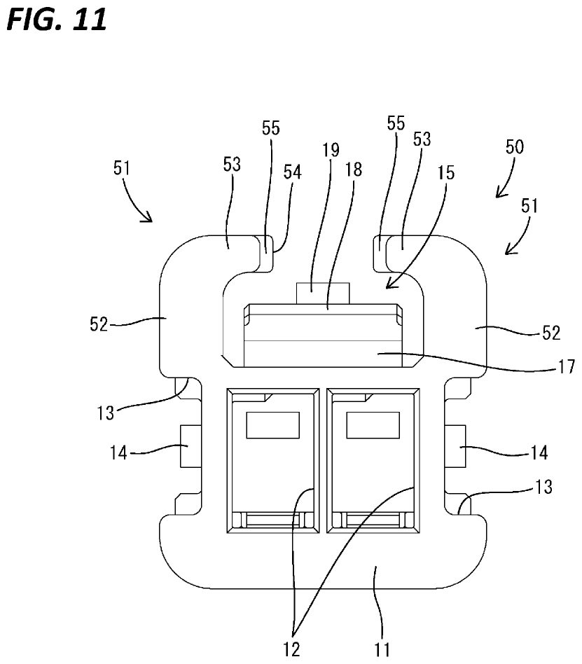

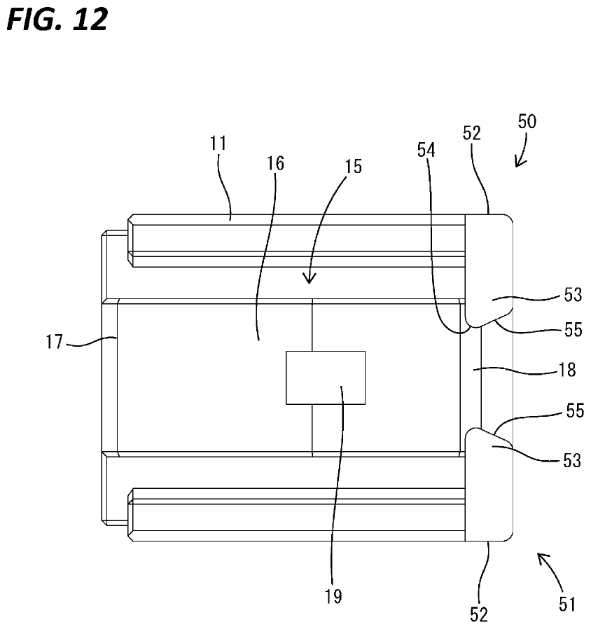

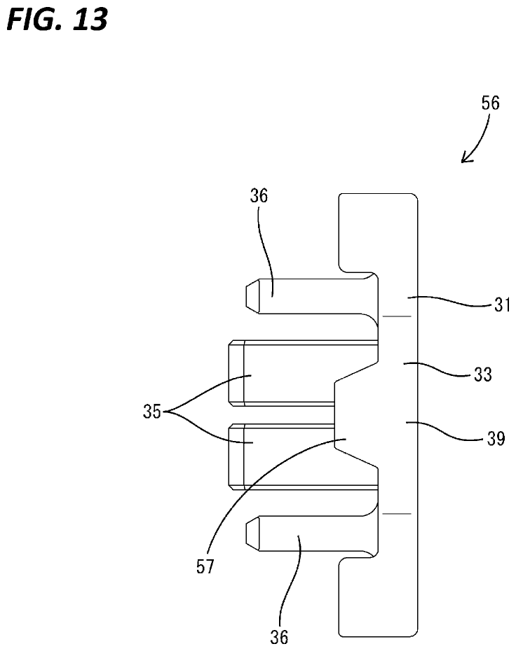

Next, a second specific embodiment of the present invention is described with reference to FIGS. 9 to 13. Note that, in the following description, a left side in FIGS. 9, 10, 12 and 13 is defined as a front side concerning a front-rear direction. Upper and lower sides shown in FIGS. 10 and 11 are directly defined as upper and lower sides concerning a vertical direction.

A female connector Fb of the second embodiment differs from that of the first embodiment in the configurations of protecting portions 51 and receiving portions 55 of a female housing 50 and a fit-in portion 57 of a retainer 56 serving as a functional member. Since other components are the same as those of the first embodiment, the same components are denoted by the same reference signs and the structures, functions and effects thereof are not described.

As shown in FIG. 11, a pair of the protecting portions 51 are provided to sandwich an operating portion 18 of a lock arm 15 from both left and right sides in the second embodiment. Each protecting portion 51 is composed of a side surface protecting portion 52 and a projection-like protecting portion 53. The side surface protecting portion 52 extends upward (toward the lock arm 15) from a rear end part of the upper surface of a terminal accommodating portion 11. The projection-like protecting portion 53 projects to either left or right from an upper end part of the side surface protecting portion 52. The projection-like protecting portion 53 on the left side surface protecting portion 52 projects rightward, and the projection-like protecting portion 53 on the right side surface protecting portion 52 projects leftward. That is, a pair of the projection-like protecting portions 53 are projecting toward each other.

A fitting space 54 is secured between facing surfaces of the left and right projection-like protecting portions 53 (i.e. extending end parts of the protecting portions 51). The fitting space 54 is open upward, downward (toward the operating portion 18), forward and rearward. The facing surfaces of the pair of left and right projection-like protecting portions 53 facing each other exhibit a function as the receiving portions 55. The both left and right receiving portions 55 are flat surfaces obliquely oriented with respect to a facing direction. In a plan view, the fitting space 54 (receiving portions 55) has such an isosceles trapezoidal shape that a facing interval between the left and right receiving portions 55 is gradually narrowed toward a front side.

As shown in FIGS. 9, 10 and 13, the retainer 56 is integrally formed with the fit-in portion 57. The fit-in portion 57 is cantilevered forward from the front surface of a wall portion 31. A formation range of the fit-in portion 57 in a lateral direction is a region corresponding to the receiving portions 55 (fitting space 54), i.e. a laterally central part of the retainer 56 (wall portion 31). A formation range of the fit-in portion 57 in the vertical direction is a region substantially corresponding to the receiving portions 55. The fit-in portion 57 is cantilevered forward from an upper edge part 39 of the opening edge of an operation hole 34 in the front surface of the wall portion 31. A plan view shape of the fit-in portion 57 is an isosceles trapezoidal shape, similarly to the fitting space 54 secured between the pair of receiving portions 55.

If the retainer 56 is properly assembled with the female housing 50, the fit-in portion 57 of the retainer 56 is fit to the receiving portions 55 (fitting space 54) of the female housing 50 as shown in FIG. 9. Since the facing interval between the pair of receiving portions 55 changes to be gradually narrowed toward the front side (same direction as an assembling direction of the retainer 56 with the female housing 50), the receiving portions 55 exhibit a guiding function. By the guiding function of the receiving portions 55, even if the retainer 56 is shifted in position in the lateral direction with respect to the female housing 50 in an assembling process, either one of left and right side surfaces of the fit-in portion 57 slides in contact with the receiving portion 55, whereby a position shift is corrected as the assembling proceeds.

If the fit-in portion 57 is fit to the receiving portions 55, a lateral relative displacement of the retainer 56 with respect to the female housing 50 is restricted. Thus, the wall portion 31 of the retainer 56 is held in a proper positional relationship with respect to the terminal accommodating portion 11. In this way, retaining projections 35 formed on the wall portion 31 and secondary locking portions 27 of female terminal fittings 24 accommodated in the terminal accommodating portion 11 are also held in a proper positional relationship. Therefore, the reliability of a function of retaining the female terminal fittings 24 by the retainer 56 is excellent.

In the plan view, if the retainer 56 is mounted in an oblique posture (i.e. improper posture) with respect to the female housing 50, a locking hole 37 of one 36 of a pair of left and right resilient locking pieces 36 is locked to a locking projection 14 of the female housing 50 and a locking hole 37 of the other resilient locking piece 36 is not locked to a locking projection 14. In this case, the fit-in portion 57 is fit in an oblique posture to the receiving portions 55. Since the fitting space 54 is open upward (toward the outer surface of the female housing 50), a fit state of the receiving portions 55 and the fit-in portion 57 can be visually confirmed from above and outside the female housing 50.

The female connector Fb of the second embodiment includes the female housing 50 into which the female terminal fittings 24 are to be mounted, and the retainer 56 to be mounted on the rear end part of the female housing 50 (terminal accommodating portion 11). The female housing 50 is formed with the lock arm 15 having the rear end part serving as the operating portion 18 for unlocking. The female housing 50 is formed with the protecting portions 51 for covering the operating portion 18. The protecting portions 51 are formed with the receiving portions 55. The retainer 56 is formed with the fit-in portion 57 to be fit to the receiving portions 55 only when the retainer 56 is properly mounted on the female housing 50.

According to this configuration, if the retainer 56 is properly mounted on the female housing 50, the fit-in portion 57 is fit to the receiving portions 55 and the retainer 56 is positioned with respect to the female housing 50 by the fitting of the receiving portions 55 and the fit-in portion 57. In this way, the retainer 56 can be held in a state properly mounted on the female housing 50. This enables the retainer 56 to properly exhibit a desired function (function of retaining the female terminal fittings 24).

In the female connector Fb of the second embodiment, the pair of protecting portions 51 are cantilevered from an outer surface of the female housing 50 (upper surface of the terminal accommodating portion 11) and disposed to laterally sandwich the operating portion 18. Extending end parts of the pair of protecting portions 51 function as the receiving portions 55 above the operating portion 18. The fit-in portion 57 is fit between the pair of receiving portions 55. According to this configuration, the fit state of the receiving portions 55 and the fit-in portion 57 can be visually confirmed.

### Third Embodiment

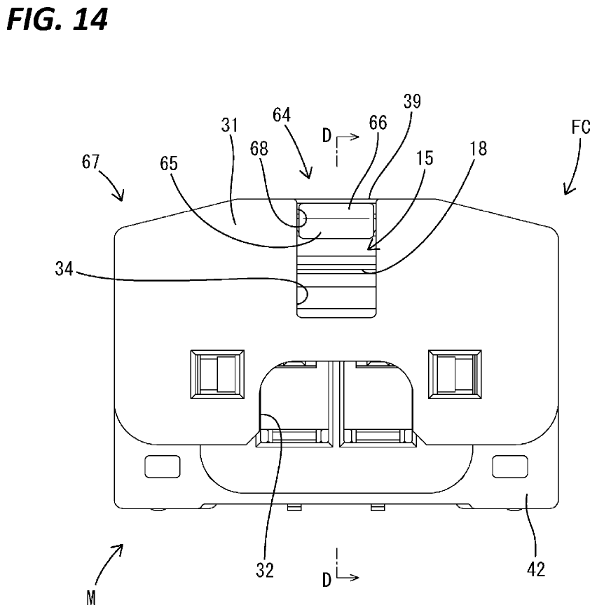

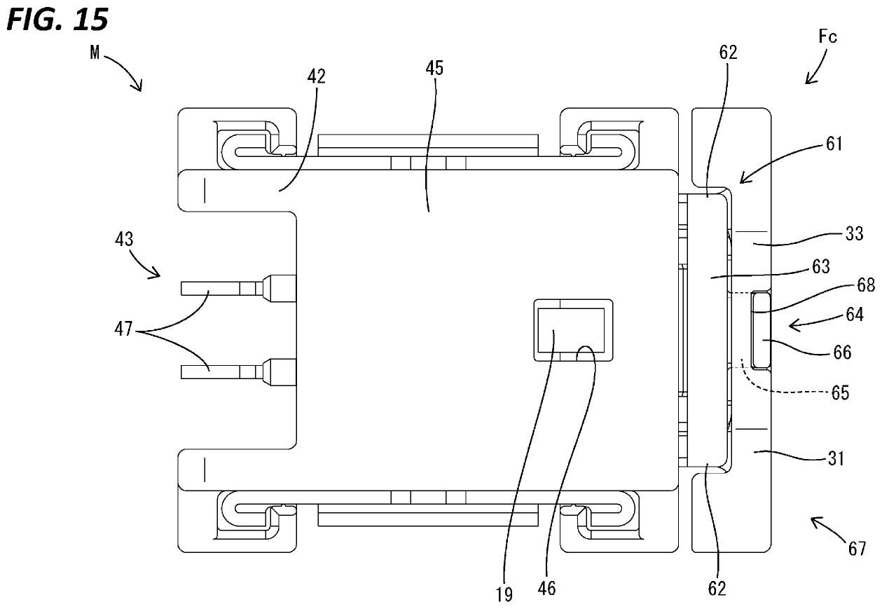

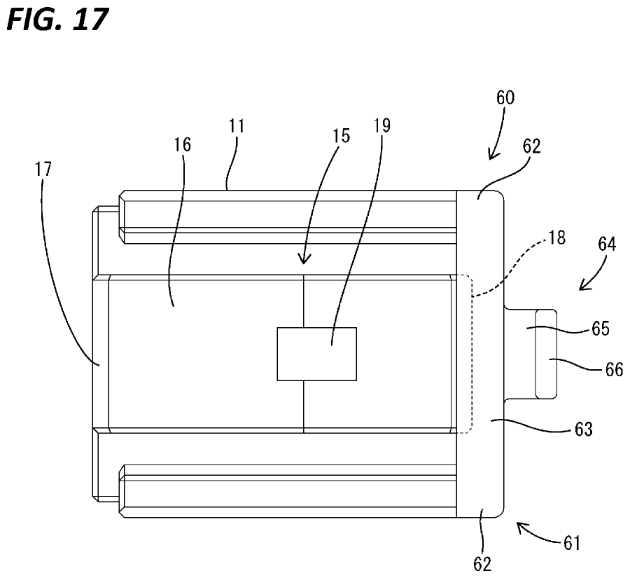

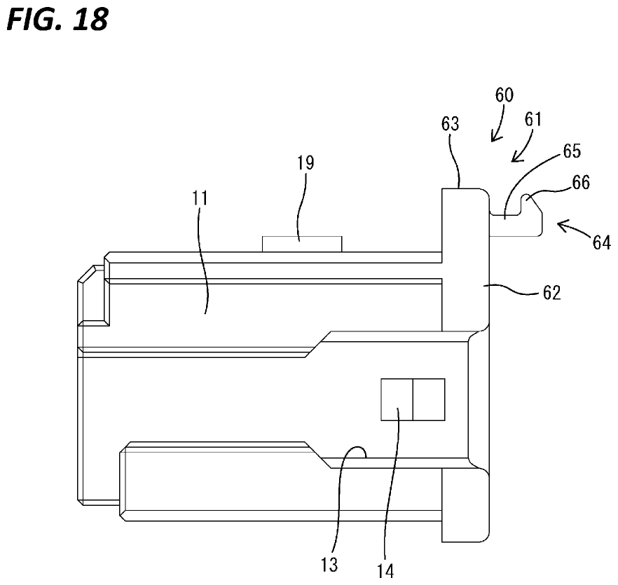

Next, a third specific embodiment of the present invention is described with reference to FIGS. 14 to 20. Note that, in the following description, a left side in FIGS. 15 to 20 is defined as a front side concerning a front-rear direction. Upper and lower sides shown in FIGS. 14, 16, 18 and 20 are directly defined as upper and lower sides concerning a vertical direction.

A female connector Fc of the third embodiment differs from that of the first embodiment in the configurations of a protecting portion 61 and a receiving portion 64 of a female housing 60 and a fit-in portion 68 of a retainer 67 serving as a functional member. Since other components are the same as those of the first and second embodiments, the same components are denoted by the same reference signs and the structures, functions and effects thereof are not described.

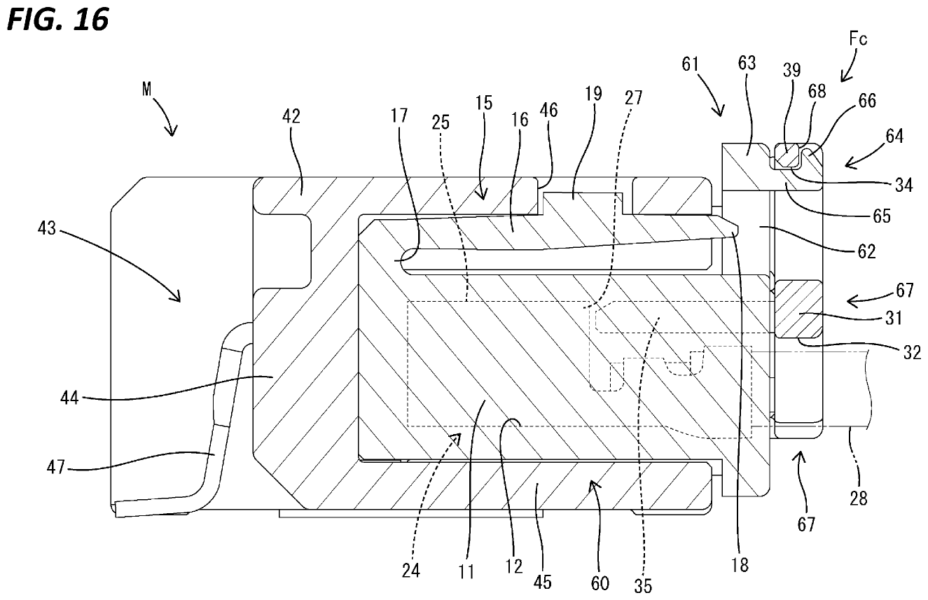

As shown in FIGS. 16 to 18, the protecting portion 61 of the third embodiment is formed into a frame shape by a pair of left and right side surface protecting portions 62 and an upper surface protecting portion 63 as in the first embodiment. The pair of left and right side surface protecting portions 62 are disposed to extend upward (toward a lock arm 15) from a rear end part of the upper surface of a terminal accommodating portion 11 and cover both left and right side surfaces of an operating portion 18. The upper surface protecting portion 63 couples upper end parts of the pair of left and right side surface protecting portions 62, and is disposed to cover the upper surface of the operating portion 18. The protecting portion 61 prevents only the interference of external matters with the operating portion 18 from above and the interference of external matters with the operating portion 18 from both left and right sides. The protecting portion 61 and the female housing 60 are not formed with a part for covering the operating portion 18 from behind.

The protecting portion 61 is integrally formed with the receiving portion 64. The receiving portion 64 is disposed in a laterally central part of the upper surface protecting portion 63, i.e. in a region corresponding to the operating portion 18 in a lateral direction. The receiving portion 64 is cantilevered forward from the upper surface protecting portion 63. In particular, the receiving portion 64 is composed of a base portion 65 in the form of a flat plate cantilevered rearward from the rear surface of the upper surface protecting portion 63 and a projection 66 projecting upward from the projecting end edge of the base portion 65. A shape viewed from a direction orthogonal to both a resilient displacement direction of the lock arm 15 and a mounting direction of the retainer 67 on the female housing 60 is defined as a side view shape. The side view shape of the receiving portion 64 is a substantially L shape.

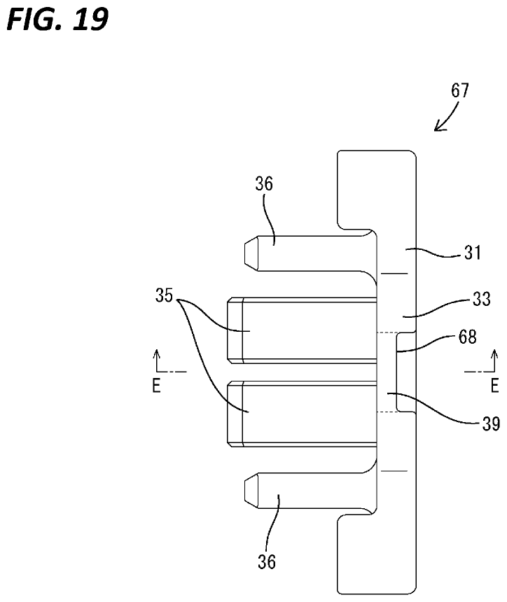

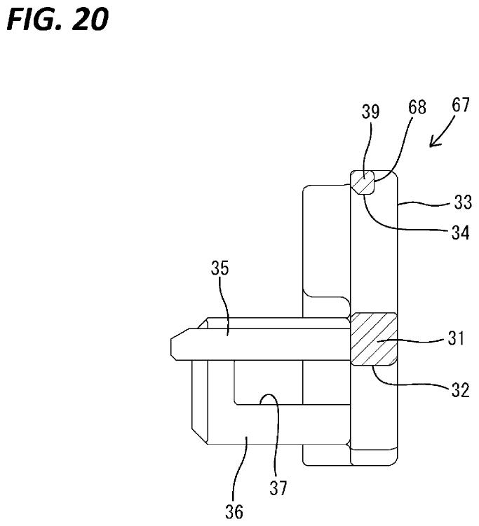

As shown in FIGS. 19 and 20, the retainer 67 is integrally formed with the fit-in portion 68. The fit-in portion 68 is formed by recessing a part of an upper end edge 39 constituting the opening edge of an operation hole 34 of the wall portion 31. In particular, the receiving portion 68 is formed by recessing a rear edge part of the lower surface of the upper edge part 39 of the operation hole 34 and a lower end edge part of the rear surface of the upper edge part 39 of the operation hole 34 into a groove. In other words, the receiving portion 68 is open downward and rearward of the upper edge part 39 of the operation hole 34. A formation range of the fit-in portion 68 in the lateral direction is a region corresponding to the receiving portion 64, i.e. a laterally central part of the retainer 67 (wall portion 31). A formation range of the fit-in portion 68 in the vertical direction is a region substantially corresponding to the projection 66 of the receiving portion 64. With the retainer 67 properly mounted on the female housing 60, the fit-in portion 68 is fit to the projection 66 of the receiving portion 64.

If the retainer 67 is properly mounted on the female housing 60 as shown in FIG. 16, the fit-in portion 68 is fit to the projection 66 of the receiving portion 64. By the fitting of the fit-in portion 68 to the receiving portion 64, a rearward relative displacement of the retainer 67 with respect to the female housing 60 and a lateral relative displacement of the retainer 67 with respect to the female housing 60 are restricted. In this way, the wall portion 31 of the retainer 67 is held in a proper positional relationship with respect to the terminal accommodating portion 11. Retaining projections formed on the wall portion 31 and secondary locking portions of female terminal fittings accommodated in the terminal accommodating portion 11 are also held in a proper positional relationship. Therefore, the reliability of a function of retaining the female terminal fittings by the retainer 67 is excellent.

In a plan view, if the retainer 67 is mounted in an oblique posture (i.e. improper posture) with respect to the female housing 60, a locking hole of one of a pair of left and right resilient locking pieces is locked to a locking projection of the female housing 60 and a locking hole of the other resilient locking piece is not locked to a locking projection. In this case, the fit-in portion 68 is kept at a position behind the projection 66 of the receiving portion 64 and the fit-in portion 68 cannot be fit to the receiving portion 64. Thus, the retainer 67 is relatively displaceable with respect to the female housing 60 and the position of the retainer 67 with respect to the female housing 60 is not stable.

The female connector Fc of the third embodiment includes the female housing 60 into which the female terminal fittings are to be mounted, and the retainer 67 to be mounted on a rear end part of the female housing 60 (terminal accommodating portion 11). The female housing 60 is formed with the lock arm 15. The rear end part of the lock arm 15 serves as the operating portion 18 for unlocking. The female housing 60 is formed with the protecting portion 61 for covering the operating portion 18. The protecting portion 61 is formed with the receiving portion 64. The retainer 67 is formed with the fit-in portion 68 to be fit to the receiving portion 64 only when the retainer 67 is properly mounted on the female housing 60.

If the retainer 67 is properly mounted on the female housing 60, the fit-in portion 68 is fit to the receiving portion 64 and the retainer 67 is positioned with respect to the female housing 60 by the fitting of the receiving portion 64 and the fit-in portion 68. In this way, the retainer 67 can be held in a state properly mounted on the female housing 60. This enables the retainer 67 to properly exhibit a desired function (function of retaining the female terminal fittings).

Further, the retainer 67 includes the operation hole 34 penetrating in the front-rear direction, and an opening edge part (upper edge part) of the operation hole 34 serves as the fit-in portion 68. The protecting portion 61 is in the form of a frame extending from the outer surface of the female housing 60 (upper surface of the terminal accommodating portion 11) and surrounding the operating portion 18. The receiving portion 64 is cantilevered from the protecting portion 61 (upper surface protecting portion 63) and fit to the fit-in portion 68 while being accommodated into the operation hole 34. According to this configuration, since a fit part of the receiving portion 64 and the fit-in portion 68 is located inside the operation hole 34, the fit part of the receiving portion 64 and the fit-in portion 68 is free from interference with external matters.

### Other Embodiments

The present invention is not limited to the above described and illustrated embodiments, but is represented by claims. The present invention is intended to include all changes in the meaning of equivalents to claims and in the scope of claims and also include the following embodiments.

(1) Although the retainer (functional member) is formed with the covering portion in the above first to third embodiments, the retainer (functional member) may not include the covering portion.

(2) Although the fit-in portion is integrally formed to the covering portion in the first to third embodiments, the fit-in portion may be formed on a part different from the covering portion.

(3) Although the functional member is the retainer for exhibiting the function of retaining the terminal fittings in the above first to third embodiments, the functional member may exhibit a function different from the terminal fitting retaining function (e.g. a function as a wire cover for bending the wires drawn out from the housing).

### LIST OF REFERENCE NUMERALS

10, 50, 60 female housing (housing)
11 terminal accommodating portion
12 terminal accommodation chamber
13 guide recess
14 locking projection
15 lock arm
16 arm body portion
17 supporting portion
18 operating portion
19 lock projection
20 protecting portion
21 side surface protecting portion
22 upper surface protecting portion
23 receiving portion
24 female terminal fitting (terminal fitting)
25 rectangular tube portion
26 crimping portion
27 secondary locking portion
28 coated wire
30, 56, 67 retainer (functional member)
31 wall portion
32 escaping recess
33 covering portion
34 operation hole (opening)
35 retaining projection
36 resilient locking piece
37 locking hole
38 fit-in portion
39 upper edge part
40 base portion
41 projection
42 male housing
43 male terminal fitting
44 terminal penetrating portion
45 receptacle
46 lock hole
47 board connecting portion
51 protecting portion
52 side surface protecting portion
53 projection-like protecting portion
54 fitting space
55 receiving portion
57 fit-in portion
61 protecting portion
62 side surface protecting portion
63 upper surface protecting portion
64 receiving portion
65 base portion
66 projection
68 fit-in portion
Fa, Fb, Fc female connector (connector)
M male connector

1. A connector, comprising:
a terminal fitting; and
a housing, the terminal fitting being mounted into the housing,
wherein:
the housing is formed with a lock arm having a rear end part serving as an operating portion for unlocking,
the housing includes a protecting portion for covering the operating portion,
the protecting portion is formed with a receiving portion,
a functional member is mounted on a rear end part of the housing, and
the functional member is formed with a fit-in portion fittable to the receiving portion when the functional member is properly mounted on the housing.

2. The connector of claim 1, wherein the functional member is formed with a covering portion for covering a region of the operating portion not covered by the protecting portion.

3. The connector of claim 2, wherein the fit-in portion is integrally formed to the covering portion.

4. The connector of claim 1, wherein:
the protecting portion is in the form of a frame extending from an outer surface of the housing and surrounding the operating portion,
the receiving portion is formed by recessing a facing surface of the protecting portion facing the operating portion, and
the fit-in portion is fit to the receiving portion while projecting from the functional member and slipping into the inside of the protecting portion.

5. The connector of claim 1, wherein:
a pair of the protecting portions are cantilevered from an outer surface of the housing and disposed to laterally sandwich the operating portion,
extending end parts of the pair of protecting portions function as the receiving portions, and
the fit-in portion is fit between the pair of receiving portions.

6. The connector of claim 1, wherein:
the functional member includes an opening penetrating in a front-rear direction,
an opening edge part of the opening serves as the fit-in portion,
the protecting portion is in the form of a frame extending from an outer surface of the housing and surrounding the operating portion, and
the receiving portion is cantilevered from the protecting portion and fit to the fit-in portion while being accommodated in the opening.

7. The connector of claim 1, wherein:
the terminal fitting is inserted into the housing from behind, and
the functional member is a retainer for holding the terminal fitting in a retained state by being mounted on the rear end part of the housing.
